(19) United States
(12) Patent Application Publication
(10) Pub. No.: US 2025/0183577 A1
(43) Pub. Date: Jun. 5, 2025

(54) OFFSHORE CONNECTOR ASSEMBLY

(71) Applicant: QUOCEANT LIMITED, Loanhead (GB)

(72) Inventors: Elizabeth DICKENS, Loanhead (GB); Richard YEMM, Loanhead (GB); Ross HENDERSON, Loanhead (GB); Jonathan BENZIE, Loanhead (GB); Ziga VRHUNEC, Loanhead (GB)

(21) Appl. No.: 18/843,020

(22) PCT Filed: Feb. 28, 2023
(86) PCT No.: PCT/GB2023/050442

§ 371 Date: Aug. 30, 2024

(30) Foreign Application Priority Data
Mar. 1, 2022 (GB) 2202837.7

(51) Int. Cl. H01R 13/453; H01R 13/523

(52) U.S. Cl. CPC H01R 13/453; H01R 13/523

(57) ABSTRACT

The present disclosure provides an offshore connector assembly comprising a first connector (100) and a second connector (200). The first connector (100) comprises a first connector body (101) and a plurality of first engaging members (108), each defining a first engaging surface (300). The second connector (200) comprises a second connector body (202) and a plurality of second engaging members (204), each defining a second engaging surface (300), configured to form a plurality of engaging surface pairs with the plurality of respective first engaging surfaces (302) when the first connector (100) is connected to the second connector (200). At least one of the first engaging surface (300) and the second engaging surface (300) of each engaging surface pair is configured to be movable relative to its respective first or second connector body (101, 202), between a first engaging surface position in which the first connector (100) is free to move away from the second connector (200), and a second engaging surface (300) position in which, by contact of a first retaining portion (306) of the first engaging surface (300) with a second retaining portion (306) of the second engaging surface of each engaging surface pair, the first connector (100) is mechanically retained relative to the second connector (200). The subsea offshore connector assembly is configured such that at least one of the first engaging surface (300) and the second engaging surface (300) of each engaging surface pair is biased towards the second engaging surface position.

### FIELD OF THE INVENTION

The present invention relates to an offshore connector assembly and parts for forming the same.

### BACKGROUND TO THE INVENTION

When installing apparatus in a marine environment, it is sometimes necessary to tether or otherwise connect the apparatus to an anchor or other steadfastly mounted structure. A structural connection is required to be sufficiently strong that the apparatus cannot become inadvertently separated from the anchor. In some examples, an electrical connection is also provided so that electrical power and/or data signals (e.g. control signals) can be transferred between the apparatus and the anchor (which may itself have an electrical connection to shore).

Often, it is necessary for the apparatus installed in the marine environment to be removed from the marine environment, either temporarily such as for maintenance or repair, or permanently such as for decommissioning.

It is in this context that the present disclosure has been devised.

### SUMMARY OF THE INVENTION

In accordance with an aspect of the present disclosure, there is provided an offshore connector assembly. The offshore connector assembly comprises: a first connector comprising a first connector body and a plurality of first engaging members, each defining a first engaging surface; and a second connector comprising a second connector body and a plurality of second engaging members, each defining a second engaging surface. Each second engaging surface is configured to form a plurality of engaging surface pairs with the plurality of respective first engaging surfaces when the first connector is connected to the second connector. At least one of the first engaging surface and the second engaging surface of each engaging surface pair is configured to be movable relative to its respective first or second connector body, between a first engaging surface position in which the first connector is free to move away from the second connector, and a second engaging surface position in which, by contact of a first retaining portion of the first engaging surface with a second retaining portion of the second engaging surface of each engaging surface pair, the first connector is mechanically retained relative to the second connector. The offshore connector assembly is configured such that at least one of the first engaging surface and the second engaging surface of each engaging surface pair is biased towards the second engaging surface position.

Thus, an offshore connector assembly can be provided which ensures mechanical connection between a first connector and a second connector, in which the engaging members cooperate to provide the mechanical connection. The assembly is configured such that the connection is biased towards the position in which the first connector is mechanically retained relative to the second connector, thereby increasing safety and convenience of the mechanical connection.

It will be understood that an offshore connector assembly is substantially any connectors for use (e.g. configured to be used) at least partially in a marine environment (i.e. away from the shore), either above or below the surface of a body of water. In some examples, the offshore connector assembly may be configured to be used in a marine environment only after connection. In other examples, the offshore connector assembly may be configured to be used in a marine environment during connection of the first connector and the second connector. In some examples, the offshore connector assembly may be a subsea connector assembly. In other words, the offshore connector assembly may be configured to be used below the surface of a body of water, at least some of the time.

The plurality of first engaging members may be at least five first engaging members. The plurality of first engaging members may be at least ten first engaging members. The plurality of first engaging members may be fewer than 100 first engaging members. The plurality of first engaging members may be fewer than twenty first engaging members. The plurality of second engaging members may be at least five second engaging members. The plurality of second engaging members may be at least ten second engaging members. The plurality of second engaging members May be fewer than 100 second engaging members. The plurality of second engaging members may be fewer than twenty second engaging members.

It will be understood that movement of the first connector away from the second connector is prevented, at least in part, by the contact between the first and second retaining portions of the first and second engaging surfaces of each engaging surface pair.

The offshore connector assembly may be configured such that at least one of the first engaging surface and the second engaging surface of each engaging surface pair is resiliently biased towards the second engaging surface position. Thus, even when a force acts to move the at least one of the first engaging surface and the second engaging surface of each engaging surface pair away from the second engaging surface position, towards the first engaging surface position, the offshore connector assembly is configured to urge movement of the at least one of the first engaging surface and the second engaging surface of each engaging surface pair to return towards the second engaging surface position. At least one of the first connector and the second connector may comprise a resiliently deformable member (e.g. a spring) to resiliently urge the at least one of the first engaging surface and the second engaging surface of each engaging surface pair towards the second engaging surface position.

The plurality of first engaging members may be distributed circumferentially about a first connection axis of the first connector. The plurality of second engaging members may be distributed circumferentially about a second connection axis of the second connector. Thus, first connector and the second connector can each have a substantially circular arrangement of engaging members. It will be understood that the first connection axis can be considered to be a centre-line of the first connector, centrally within the plurality of first engaging members, and extending to the second connection axis. Similarly, the second connection axis can be considered to be a centre-line of the second connector, centrally within the plurality of second engaging members, and extending to the first connection axis.

At least two of the plurality of first engaging members may be fixedly mounted to each other, such that the at least two of the plurality of first engaging members are movable together relative to the first connector body. It may be that each of the plurality of first engaging members are fixedly mounted to each other, such that all of the plurality of first engaging members are movable together. Thus, there need not be a movement actuator provided for each movable engaging member. It may be that each of the first engaging members capable of movement relative to the first connector body are fixedly mounted to each other, such that all of the plurality of movable first engaging members are movable together.

At least two of the plurality of second engaging members may be fixedly mounted to each other, such that the at least two of the plurality of second engaging members are movable together relative to the second connector body. It may be that each of the plurality of second engaging members are fixedly mounted to each other, such that all of the plurality of second engaging members are movable together. Thus, there need not be a movement actuator provided for each movable engaging member. It may be that each of the second engaging members capable of movement relative to the second connector body are fixedly mounted to each other, such that all of the plurality of movable second engaging members are movable together.

Each of the plurality of first engaging members may be sized to be no wider than a respective spacing between each of the plurality of second engaging members. Each of the plurality of second engaging members may be sized to be no wider than a respective spacing between each of the plurality of first engaging members. Thus, each of the first engaging members can pass through a respective spacing between adjacent second engaging members, before contact is made between the retaining portions of each engaging surface in the second engaging surface position.

The first retaining portion may be arranged to face away from a direction in which the first connector is configured to move towards the second connector when the first connector is connecting to the second connector. The second retaining portion may be arranged to face away from a direction in which the second connector is configured to move towards the first connector when the first connector is connecting to the second connector.

The first engaging surface of at least one engaging surface pair may further comprise a first angled portion, and the second engaging surface of the at least one engaging surface pair may further comprise a second angled portion. It may be that the first engaging surface of each engaging surface pair further comprises a respective first angled portion, and the second engaging surface of each engaging surface pair further comprises a respective second angled portion.

The first angled portion and the second angled portion may each be arranged such that sliding contact between the first and second angled portions is provided when the first connector is moved towards the second connector, whereby to urge movement of the first engaging surface and the second engaging surface of the at least one or each engaging surface pair towards the first engaging surface position. Thus, the first engaging members of the first connector can be moved relative to the second engaging members of the second connector, to facilitate the first connector to be brought into connection with the second connector with at least one of the first engaging surface and the second engaging surface of each engaging surface pair being moved into the first engaging surface position.

The movement urged may be in a direction having a component transverse to a direction of movement of the first connector towards the second connector. The direction may have a component circumferential to the first connection axis and/or the second connection axis. In other words, the angled portions provide for lateral movement of the first engaging members relative to the second engaging members to ensure the engaging members can pass by each other during the connection operation. The movement may be a rotational movement about the first connection axis and/or the second connection axis.

It will be understood that an angled portion of the engaging surface defines a surface inclined at a non-perpendicular angle with respect to the retaining portion of the respective engaging surface. Each angled portion may be inclined at an angle of between 20 degrees and 70 degrees with respect to a surface normal through the retaining portion of the respective engaging surface. Each angled portion may be inclined at an angle of less than 45 degrees with respect to a surface normal through the retaining portion of the respective engaging surface. Thus, the first angled portion and the second angled portion can cause lateral movement of the first and second engaging surfaces by sliding contact between the first angled portion and the second angled portion, without excessive resistance from friction.

The first angled portion and the second angled portion of the at least one engaging surface pair may each be further arranged such that sliding contact between the first and second angled portions urges movement of the connector body of the at least one of the first engaging surface and the second engaging surface of each engaging surface pair to change axial alignment between the first connector and the second connector during movement of the first connector towards the second connector.

Thus, the angled portions ensure that the first connector and the second connector are each centralised relative to the connection axis of the other, to ensure alignment of the first engaging members with the second engaging members, and/or alignment of the first connection axis with the second connection axis.

The first angled portion and the second angled portion of the at least one engaging surface pair may each be further arranged such that sliding contact between the first and second angled portions urges movement of the connector body of the at least one of the first engaging surface and the second engaging surface of each engaging surface pair to improve axial alignment between the first connector and the second connector during movement of the first connector towards the second connector.

It may be that a plane defined by at least one of the angled portions intersects the respective connection axis at an axial position above or below the level of the respective angled portion. In other words, at least one of the angled portions can be considered to be inclined inwardly or outwardly. As a result, a sideways force can be exerted on the first and second connectors during the connection process, whereby to improve the translational alignment of the first and second connectors during connection.

The first engaging surface of at least one engaging surface pair may further comprise a first slip portion extending from the first retaining portion. The second engaging surface of the at least one engaging surface pair may further comprise a second slip portion extending from the second retaining portion. The first slip portion may be arranged to contact the second slip portion during movement of the first engaging surface and the second engaging surface of the at least one engaging surface pair from the second engaging surface position when the first connector is mechanically retained relative to the second connector, towards the first engaging surface position. The first slip portion and the second slip portion may each be configured such that, when the first slip portion contacts the second slip portion during movement of the first engaging surface and the second engaging surface of the at least one engaging surface pair from the second engaging surface position towards the first engaging surface position, further movement of the first engaging surface and the second engaging surface of the at least one engaging surface pair from the second engaging surface position towards the first engaging surface position is caused.

Thus, once the slip portions are in mutual contact, the first engaging surface and the second engaging surface of the engaging surface pair may continue to slide over each other, even without a releasing force being applied. In this way, it will be seen that disconnecting the first connector from the second connector is simplified. It May be that the offshore connector assembly is used in applications where very large mechanical forces can be carried across the connection, in tension. Therefore, it is important that the connection can be disengaged safely without damage to the components of the first connector or the second connector.

It may be that at least one of a shape and surface roughness of the first slip portion and the second slip portion is configured such that, when the first slip portion contacts the second slip portion during movement of the first engaging surface and the second engaging surface of the at least one engaging surface pair from the second engaging surface position towards the first engaging surface position, further movement of the first engaging surface and the second engaging surface of the at least one engaging surface pair from the second engaging surface position towards the first engaging surface position is caused.

It may be that the or each first slip portion extends from the respective first retaining portion and the or each second slip portion extends from the respective second retaining portion. It may be that a radius of curvature of any convex region of the or each first slip portion is configured to be sufficiently large so as to substantially avoid (e.g. avoid) contact stress between the first slip portion and the second slip portion at a level to cause local plastic deformation of the first connector or the second connector. The radius of curvature of any convex region of the or each first slip portion may be greater than 5 millimetres. The radius of curvature of any convex region of the or each first slip portion may be greater than 5% of a width of the first retaining portion. A lateral extent of the first slip portion in a direction of a length of the first retaining portion (the direction in which the first retaining portion is arranged to move relative to the second retaining portion when moving from the second engaging surface position towards the first engaging surface position), may be less than 50% of the length of the first retaining portion. The lateral extent of the first slip portion may be less than 30%. The lateral extent of the first slip portion may be less than 5 millimetres.

It may be that a radius of curvature of any convex region of the or each second slip portion is configured to be sufficiently large so as to substantially avoid (e.g. avoid) contact stress between the first slip portion and the second slip portion at a level to cause local plastic deformation of the first connector or the second connector. The radius of curvature of any convex region of the or each second slip portion may be greater than 5 millimetres. The radius of curvature of any convex region of the or each second slip portion may be greater than 5% of a width of the second retaining portion. A lateral extent of the second slip portion in a direction of a length of the second retaining portion (the direction in which the second retaining portion is arranged to move relative to the first retaining portion when moving from the second engaging surface position towards the first engaging surface position), may be less than 50% of the length of the second retaining portion. The lateral extent of the second slip portion may be less than 30%. The lateral extent of the second slip portion may be less than 5 millimetres.

At least one of the first retaining portions may extend at least 50 percent of the circumferential length of the respective first engaging member (i.e. about the first connection axis). At least one of the second retaining portions may extend at least 50 percent of the circumferential length of the respective second engaging member (i.e. about the second connection axis).

The offshore connector assembly may further comprise a linear actuator operable to exert a releasing force on at least one engaging member of the at least one of the first engaging surface and the second engaging surface movable relative to its respective first or second connector body. Thus, movement can be caused from the second engaging surface position towards the first engaging surface position by operation of the linear actuator. The offshore connector assembly may further comprise a linear actuator operable to exert a releasing force on each engaging member of the at least one of the first engaging surface and the second engaging surface movable relative to its respective first or second connector body.

The linear actuator may be an electric actuator. The linear actuator may be a hydraulic actuator.

The offshore connector assembly may be configured such that the at least one of the first engaging surface and the second engaging surface movable relative to its respective first or second connector body is free to move from the second engaging surface position towards the first engaging surface position without operation of the linear actuator. In other words, the linear actuator is mounted so as not to retard or prevent movement of the respective engaging surface relative to its respective connector body from the second engaging surface position towards the first engaging surface position. As a result, once the first and second slip portions are in mutual contact and the first engaging surface is urged to move relative to the second engaging surface towards the first engaging surface position without requiring further lateral force (e.g. from the linear actuator), the respective first or second engaging member is free to move away from an arm of the linear actuator.

The offshore connector assembly may further comprise a slotted linkage arranged between the respective first or second connector body and the first or second engaging member, such that the respective engaging member is movably connected to the respective connector body via the linear actuator and the slotted linkage. The slotted linkage defines a slot therein, whereby to permit sliding movement of the linear actuator relative to at least one of the respective engaging member and the respective connector body. Thus, the engaging member can be free to move at a speed greater than an extension (or contraction) speed of the linear actuator if necessary.

The second engaging surface of each engaging surface pair may be configured to be movable relative to the second connector body, between the first engaging surface position and the second engaging surface position. Thus, it may specifically be the second engaging surface of each engaging surface pair which moves, rather than the first engaging surface.

In another example, it may be that the first engaging surface of each engaging surface pair may be configured to be movable relative to the first connector body, between the first engaging surface position and the second engaging surface position.

The first connector may comprise one or more first electrical contacts. The second connector may comprise one or more second electrical contacts. The second electrical contacts may be configured to form one or more electrical contact pairs with the one or more respective first electrical contacts when the first connector is connected to the second connector. At least one of the first connector and the second connector may comprise one or more movable contact covers configured to be movable between a first cover position in which a cover surface of each of the one or more movable contact covers cover the respective first or second electrical contact, and a second cover position in which the cover surface of each of the one or more movable contact covers is removed from the respective first or second electrical contact. The offshore connector assembly may be configured such that movement of the first connector towards the second connector causes movement of the one or more movable contact covers from the first cover position into the second cover position. The offshore connector assembly may alternatively or additionally be configured such that movement of the first connector away from the second connector causes movement of the one or more movable contact covers from the second cover position into the first cover position.

Thus, an electrical connection may be provided across the offshore connector assembly in addition to the mechanical connection. The movable contact covers ensure that the electrical contacts on the respective connector are exposed only as part of connecting the first connector to the second connector, and further that the movable contact covers return to shield the respective electrical contacts as part of the first connector being disconnected from the second connector. In this way, biofouling of at least some of the electrical contacts can be prevented by using the movable contact covers.

This in itself is believed to be novel and so, in accordance with another aspect, the present disclosure provides an offshore connector assembly comprising: a first connector comprising one or more first electrical contacts; and a second connector comprising one or more second electrical contacts. The one or more second electrical contacts are configured to form one or more electrical contact pairs with the one or more respective first electrical contacts when the first connector is connected to the second connector. One of the first connector and the second connector comprises one or more movable contact covers configured to be movable between a first cover position in which a cover surface of each of the one or more movable contact covers cover the respective first or second electrical contact, and a second cover position in which the cover surface of each of the one or more movable contact covers is removed from the respective first or second electrical contact. The offshore connector assembly is configured such that: movement of the first connector towards the second connector causes movement of the one or more movable contact covers from the first cover position into the second cover position, and movement of the first connector away from the second connector causes movement of the one or more movable contact covers from the second cover position into the first cover position.

Thus, an electrical connection may be provided across an offshore connector assembly. The movable contact covers ensure that the electrical contacts on the respective connector are exposed only as part of connecting the first connector to the second connector, and further that the movable contact covers return to shield the respective electrical contacts as part of the first connector being disconnected from the second connector. In this way, biofouling of at least some of the electrical contacts can be prevented by using the movable contact covers.

The one or more first electrical contacts and the one or more second electrical contacts may be configured to conduct power and/or control signals between the two connectors of the offshore connector assembly.

The one or more movable contact covers may be comprised in the first connector. The one or more movable contact covers may be comprised in the second connector.

The first connector may further comprise one or more contact cover bed portions each having a shield surface arranged to cover the respective cover surface when the one or more movable contact covers are in the first cover position. Thus, biofouling of the cover surface of each of the movable contact covers can be reduced or even substantially prevented when the first connector is connected to the second connector.

Typically, the shield surface is substantially flat.

The one or more movable contact covers may each be rotatable between the first cover position and the second cover position. The one or more movable contact covers may each be slidable between the first cover position and the second cover position. Thus, the sliding action can help to remove any biofouling contaminants on either or both of the respective electrical contacts and the shield surface.

The second connector may further comprise one or more elongate protrusions. The first connector may comprise one or more movable portions, mechanically coupled to the one or more movable contact covers, such that movement of the one or more movable portions causes movement of the one or move movable contact covers between the first cover position and the second cover position. The offshore connector assembly may be configured such that when the first connector is moved towards the second connector, the one or more elongate protrusions together contact the one or more movable portions and cause movement thereof, to move the one or more movable contact covers from the first cover position into the second cover position. Thus, there is provided a particularly efficient mechanism for causing movement of the one or more movable contact covers from the first cover position into the second cover position as part of connecting the first connector to the second connector.

The offshore connector assembly may be configured such that when the first connector is moved away from the second connector, the one or more elongate protrusions together break contact with the one or more movable portions and permit movement thereof, to permit movement of the one or more movable contact covers from the second cover position into the first cover position. Thus, there is provided a particularly efficient mechanism for causing movement of the one or more movable contact covers from the second cover position into the first cover position as part of disconnecting the first connector from the second connector.

The one or more movable contact covers are biased towards the first cover position. Thus, when the first connector is disconnected and moved away from the second connector, the one or more movable contact covers will automatically be caused to return to the first cover position, thereby reducing or even preventing biofouling on the respective one or more first or second electrical contacts.

The first connector may be arranged to extend away from the second connector towards a ground surface. The second connector may be arranged to be provided as part of a deployable marine apparatus. The deployable marine apparatus may be tethered to the ground surface at least partially by the subsea connector assembly.

The deployable marine apparatus may be mechanically and/or electrically connected to a further component by the subsea connector assembly.

The ground surface may be a seabed. The deployable marine apparatus may be a power generating apparatus. The deployable marine apparatus may be a floating installation. The deployable marine apparatus may be configured to transmit at least one of power and or control signals via the subsea connector assembly.

The present disclosure extends to a kit of parts for forming the offshore connector assembly as described herein. The kit of parts comprises the first connector and the second connector, each as described herein.

The present disclosure extends to a first connector for an offshore connector assembly. The present disclosure extends to a second connector for an offshore connector assembly.

### DESCRIPTION OF THE DRAWINGS

An example embodiment of the present invention will now be illustrated with reference to the following Figures in which:

FIG. 1 shows an example of a component of a connector assembly as described herein;

FIG. 2 shows a close-up view of movable covers to be provided as part of a component of a connector assembly as described herein;

FIG. 3 shows an example of a further component of the connector assembly of FIG. 1;

FIG. 4 shows a close-up view of a cross-section through part of the further component shown in FIG. 3;

FIG. 5 shows an example of an engaging member as described herein;

FIGS. 6(a) to 6(d) are schematic diagrams illustrating stages of engagement of the engaging members during mechanical connection and disconnection of components of examples of the connector assembly as described herein;

FIG. 7 shows an example of a connector assembly as described herein, in a partially connected configuration; and

FIG. 8 shows the connector assembly of FIG. 7, in a fully connected configuration.

### DETAILED DESCRIPTION OF AN EXAMPLE EMBODIMENT

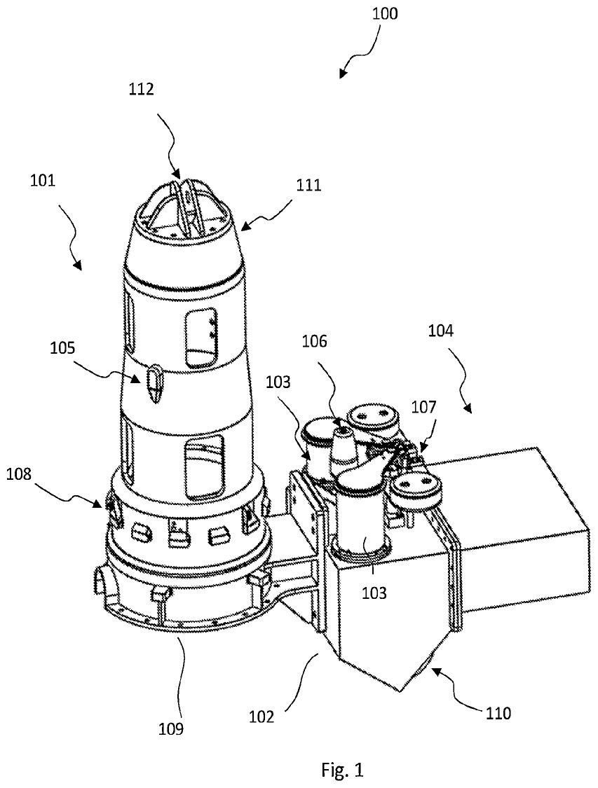

FIG. 1 shows a first connector 100 of a connector assembly as described herein. The first connector 100 consists of a connector body 101 and an electrical mounting carriage 102 extending from the connector body 101. The electrical mounting carriage 102 is provided with a pair of first electrical connectors 103 and a subsea junction box 104. A course rotational alignment pin 105 extends radially from a surface of the connector body 101. A fine alignment cone 106 extends between the pair of first electrical connectors 103 in a direction away from the electrical mounting carriage 102. A fine rotational alignment channel 107 is defined by a portion of the electrical mounting carriage 102. A set of first engaging members 108, in the form of wedged shaped teeth 108, extend radially away from the surface of the connector body 101. FIG. 1, shows the first connector 100 in a disconnected configuration. In this example, the first connector 100 is typically located subsea when disconnected and can be supported away from a seabed (such as at the surface of the sea) by subsea buoyancy (not shown).

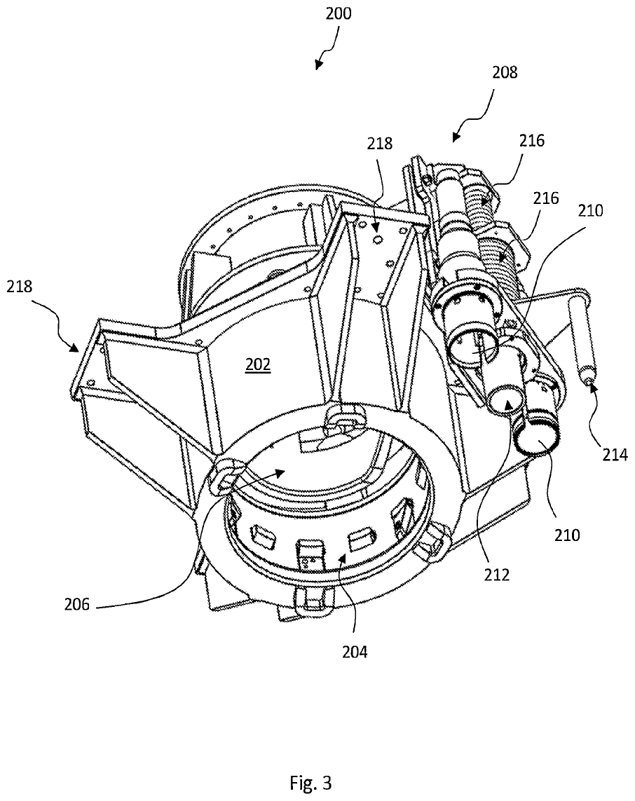

The first connector 100 is orientated such that a mooring connection point 109 and a subsea cable connection flange 110 are on a lower side, typically closer to the seabed. The mooring connection point 109 is used for connection to one or more mooring lines (not shown in this view). The subsea cable connection flange 110 provides the entry point for a subsea electrical or/and communications cable into the subsea junction box 104. Within the subsea junction box 104, the cable is split out and electrically connected to the first electrical connectors 103. In this embodiment the first electrical connectors 103 are wet-mate connectors. In other words, it is intended that the first electrical connectors 103 can be connected to a second connector (to be described with reference to FIG. 3 hereinafter), in a wet environment (including when fully submerged).

At a top side of the first connector 100, an upper bullnose piece 111 provides a connection eye 112 into which an installation line (not shown) can be connected. The installation line can be connected to the connection eye 112 in a manner that allows easy removal after the connection operation has been completed, such as via a hook or slippable line. In this way, installation lines can be used to draw up the first connector 100 during connection of the first connector 100 to the second connector, as described further hereinafter.

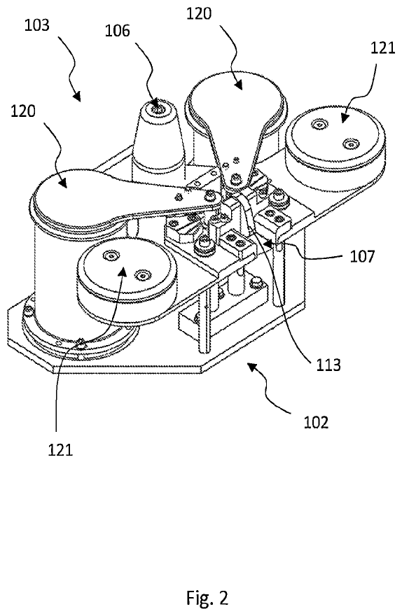

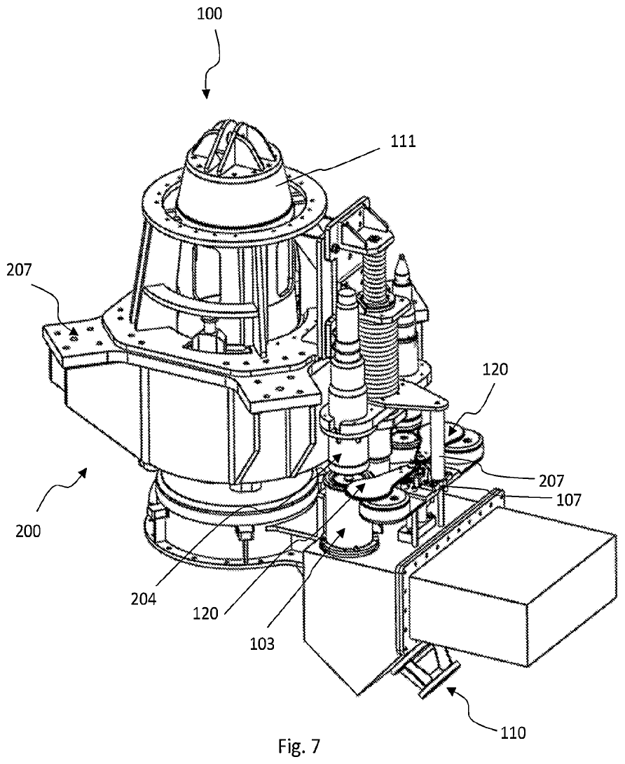

FIG. 2 shows a close-up view of the first electrical connectors 103 of FIG. 1, and some of their associated components. Each of the first electrical connectors 103 is provided with a movable contact cover 120 to cover a contact surface of the first electrical connectors 103 when in the disconnected configuration. The movable contact covers 120 protect the first electrical connectors 103 from impact, biofouling or other contaminants when they are left subsea unplugged. A pair of protection pads are also provided alongside the first electrical connectors 103. The movable contact covers 120 are pivotably connected to the electrical mounting carriage 102 and can each be rotated between a first position in which each movable contact cover 120 covers the contact surface of the respective first electrical connector 103, and a second position in which each movable contact cover 120 covers the protection pads 121. In other words, the movable contact covers 120 sit over the protection pads 121 when the first electrical connectors 103 are in the connected configuration. The purpose of the protection pads 121 is to protect the underside of the movable contact covers 120 from impact, biofouling or other contaminants when the first electrical connectors 103 are in the connected configuration and therefore the movable contact covers 120 are not covering the contact surface of the first electrical connectors 103. A movable tab 113 is also provided which is configured to cause rotation of the movable contact covers 120 from the first position to the second position when moved, such as by rotation. As will be described further with reference to FIG. 7 hereinafter, the movable tab 113 is arranged to be moved by engagement of a component of a second connector. The movable contact covers 120 are spring-loaded so as to be biased into the first position so as to protect the pair of first electrical connectors 103 when disconnected.

FIG. 3 shows a second connector 200 for connecting with the first connector 100 described hereinbefore with reference to FIGS. 1 and 2. The second connector 200 comprises a second connector body 202. The second connector body 202 has extending radially inwards therefrom a second set of engaging members 204 which are an opposing wedge shape to the first engaging members of the first connector. The second connector body 202 defines an open channel 206. The second set of engaging members 204 extend radially inward into the open channel 206. The second connector 200 further comprises an electrical mounting carriage 208 which provides a pair of second electrical connectors 210.

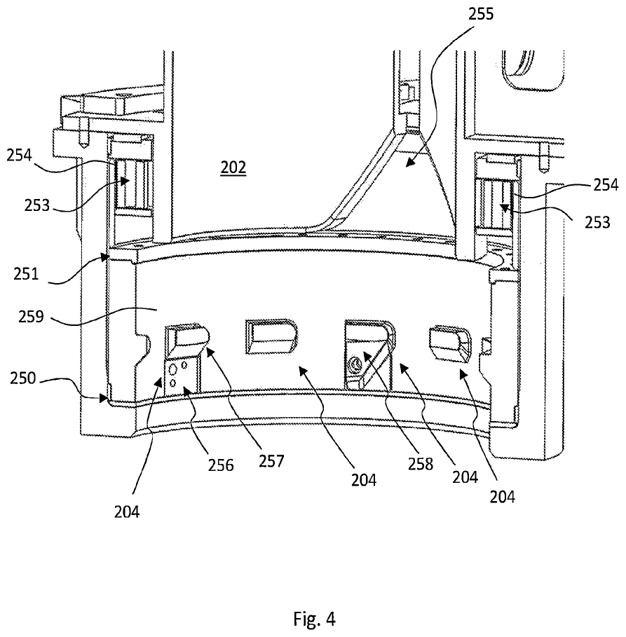

The open channel 206 includes a rotational alignment channel (more clearly visible in FIG. 4) which engages with the alignment pin 105 on the first connector 100. The electrical mounting carriage 208 also comprises a fine alignment conical tube 212 which defines an opening to engage with the fine alignment cone feature 106 on the first connector 100. A rotational alignment spike 214 is included on the electrical mounting carriage 208 to provide further rotational alignment of the second connector 200 as it connects with the first connector 100. The rotational alignment spike 214 also acts as part of the mechanism to cause movement of the movable contact covers 121 as explained later. The electrical mounting carriage 208, in this embodiment, is further provided with a pair of springs 216 mounted co-axially to one another. The pair of springs 216 are provided between the second electrical connectors 210 and a portion of the electrical mounting carriage 208 rigidly connected to the second connector body 202 such that the second electrical connectors 210 can be movable relative to the second connector body 202. In this way, the use of the pair of springs 216 provide a compliance in the electrical mounting carriage 208 which ensures that the electrical connection, when completed, is mechanically isolated from in-service relative movement between the first connector 100 and the second connector 200. This prolongs life and increases reliability of the electrical/communications connection made via the first electrical connectors 103 and the second electrical connectors 210.

In this embodiment the second connector 200 is further provided with structural attachment features 218 which enable it to be directly bolted to a marine structure such as a wave or tidal machine, or other marine structure. The open channel 206 allows an installation line to run through the middle to a winch which can be located onboard the marine structure or onboard an installation vessel. Where the installation line is connected to the connection eye 112 of the first connector 100 as described hereinbefore, this allows the winch to be used to pull the first connector 100 towards the second connector 200.

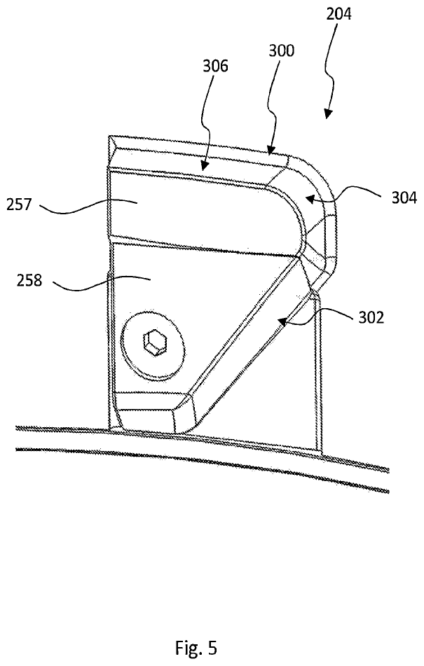

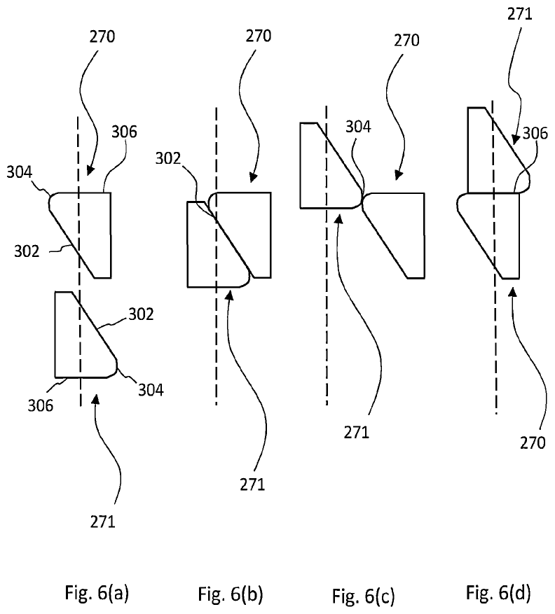

FIG. 4 shows a cross-sectional view of part of the second connector shown in FIG. 3. In this view, it can be seen that the second engaging members 204 are provided in a lower region of the second connector 200, on a cylindrical ring 259. The cylindrical ring 259 is rotatable relative to an upper portion of the second connector body 202. A first and second radial bearing 250, 251 are provided such that the second engaging members 204 can move rotationally on the cylindrical ring 259. The engaging members 204 are distributed circumferentially on an inner face of the cylindrical ring 259, each extending radially inwards as described hereinbefore. A series of compression springs 253 are housed circumferentially within two spring pockets 254, at a region of the second connector 200 above the cylindrical ring 259. The compression springs 253 are arranged to oppose free rotation of the cylindrical ring 259 in a first sense. In other words, when the cylindrical ring 259 is rotated slightly in a first rotational direction, the compression springs 253 are caused to compress, whereby to resist the rotation and to urge the cylindrical ring 259 in a second rotational direction, opposite to the first rotational direction. A set of release actuators (not shown) are mounted such that they can cause rotation of the cylindrical ring 259 with the second engaging members 204 relative to the second connector body 202, with the purpose of unlatching the first engaging members from the second engaging member 204, as described further hereinafter with reference to FIGS. 5 and 6(a) to 6(d). This view of the second connector 200 also allows the rotational alignment channel 255 to be clearly seen. The rotational alignment channel 255 is the channel into which the coarse rotational alignment pin 105 is directed and retained during connection of the first connector 100 to the second connector 200.

FIG. 4 also shows that there are several engaging members 204 located at intervals. In this embodiment each engaging member 204 consists of a machined, load-bearing tab 257, with some engaging members 204 also having a bolted-on wedge section 258. The face 256 shows where the wedge section can be attached via mounting-holes defined in the cylindrical ring 259.

In this embodiment, the second connector 200 typically includes actuators and an associated control system, the compression springs, and the moveable engaging members. These are the more complex parts of the connector assembly and locating these on the second connector 200, which is typically attached to the marine structure ensures they are easily recoverable for inspection, maintenance and/or repair.

FIG. 5 shows a close-up view of the detail of one of the engaging members 204 of the second connector 200, of the type having the wedge section 258 described hereinbefore with reference to FIG. 4, though could equally be a view of one of the first engaging members 108 of the first connector 100, which is substantially similar in appearance. It will be understood that the first engaging members 108 of the first connector 100 have a wedge shape which opposes the wedge shape of the second engaging members 204 of the second connector 200, such that a wedged surface of each engaging member 108, 204 run up each other during connection of the first connector 100 and the second connector 200. This action causes the second engaging members 204 to be driven to an ‘open position’ against the compression springs 253. As the engaging members 108, 204 move fully past each other the second engaging members 204 can spring back into a locked position by action of the compression springs 253.

It can be seen that the engaging member 204 is provided with an engaging surface 300, which will be understood to be any surface of the engaging member 204 to be contacted by the respective engaging surface of the corresponding engaging member 108 of the first connector 100, forming an engaging surface pair with the engaging member 204 of the second connector 200, during connection and/or disconnection between the first connector 100 and the second connector 200. The engaging surface is provided by a plurality of different portions 302, 304, 306, each having a different functional purpose during connection and/or disconnection between the first connector 100 and the second connector 200. A portion of the engaging surface 300 is provided by an angled portion 302, in the form of an angled run-up surface 302, in this example forming an edge face of the wedge section 258. The engaging surface is further provided by a slip portion 304, in the form of a curved slip surface 304, extending away from a first end of the angled run-up surface 302. The engaging surface 300 is further provided by a retaining portion 306 in the form of a straight loaded surface 306, itself extending away from the curved slip surface 304. In this example, each of the curved slip surface 304 and the straight loaded surface 306 form edge faces of the load bearing tab 257.

The angled run-up surface 302 is non-perpendicular to a local region of a cylindrical face of the cylindrical ring, which acts to centre the first engaging members 108 relative to the second engaging members 204, during contact of the angled run-up surfaces 302 of the first and second engaging members 108, 204.

The curved slip surface 304 has a minimum radius of curvature sufficiently large (in this example greater than 5 mm) so as to reduce the localised contact stress between the engaging members 108, 204 both as they disconnect and also as they connect, in particular where the two engaging members 108, 204 are in contact through the curved slip surface 304 of each engaging member 108, 204 of the respective engaging surface pairs. In addition, the curved profile of the curved slip surface 304 acts such that once the system has started to release during disconnection, it back-drives the second engaging members 204 away from the first engaging members 108 so as to rapidly and efficiently self-release the two sets of engaging members 108, 204, without requiring a releasing force to be applied to complete the disconnection. The inclusion of the curved profile is important to prevent a point during release when the contact forces would otherwise rise and become (in effect) infinite. The shape of the curved slip surface 304 is also chosen such that the length and area of the straight loaded surface 306 can be maximised to ensure the load bearing surface is as large as possible. In other words, the size of the curved slip surface 304 is minimised as much as possible whilst still sufficiently reducing the local contact stress as described above. By maximising the proportion of a lateral portion of the engaging surface 300 of the engaging member 204 provided by the straight loaded surface 306, this ensures that the maximum mechanical load can be carried through the straight loaded surfaces 306 when the first connector 100 is connector to the second connector 200, thereby reducing the circumferential size of the first and second connectors 100, 200 required for supporting a given load. The profile of the curved slip surface 304 may be a constant radius or preferably be a specific profile designed to create an optimal balance between the above characteristics. In other words, in some examples, the curved slips surface 304 takes the form of a compound curve, having a larger radius of curvature in a portion adjacent to the straight loaded surface 306 gradually reducing to a smaller radius of curvature in a portion adjacent to the angled run-up surface 302, thereby minimising the proportion of the engaging surfaces that are required for the curved portions, thereby maximising load carrying capacity once engaged.

The straight loaded surface 306 is the portion of the engaging surface 300 of the engaging members 108, 204 arranged to be in mutual contact when the first connector 100 is connected to the second connector 200.

In this embodiment, some of the engaging members 204 include a bolted section 258 to ease manufacture and allow replacement if required. Alternatively, the full tooth can be machined in place. In this embodiment not all engaging members 204 are full wedge-shaped teeth. In other words, not all engaging members 204 include the bolted section 258 (as can be seen clearly from FIG. 4), which further simplifies manufacturing.

A connection operation between the first connector 100 and the second connector 200, hereinbefore described, will now be described.

As described hereinbefore, to connect the first connector 100 to the second connector 200, a first end of an installation line is passed through the open channel 206 through the second connector body 202 of the second connector and attached to the connection eye 112 on the upper bullnose piece 111 of the first connector 100. A second end of the installation line, opposite the first end, is typically connected to a winch mounted directly or indirectly to the second connector 200 (such as mounted to an offshore structure to which the second connector 200 is mounted). During the connection operation the winch is activated to shorten the installation line thus drawing the first connector 100 up towards the second connector 200. As the first and second connectors 100, 200 come into contact, the course rotational alignment pin 105, extending radially outward from the first connector body 101 of the first connector 100, slides into the rotational alignment channel 255, defined in the second connector body 202 of the second connector 100, to correct for any rotational and axial misalignment of the two connectors. The tapered shape and the profile of the first connector body 101, and the internal shape and the profile of the second connector 200 ensure that the progressive insertion of the first connector body 101 into the open channel 206 of the second connector 200 bring the first and second connectors 100, 200 into close axial alignment without jamming. Furthermore, the course rotational alignment pins 105 on the first connector 100 engage with a tapered opening of the rotational alignment channel 255 on the second connector 200 to bring the first and second connectors 100, 200 into close rotational alignment without jamming. These features combined provide course rotational and positional alignment such that the system is ready for fine alignment and mechanical and electrical connection to be made. It will be understood that some rotational alignment can also be performed before this stage by other components of the apparatus (not shown).

As the first connector 100 is moved further through the open channel 206 of the second connector 200, the engaging members 108, 204 that have a wedge shape come into contact via their respective angled run-up surfaces 302. Further axial movement of the first connector 100 towards the second connector 200 results in mechanical latching of the first connector 100 to the second connector 200, as described further hereinafter with reference to FIGS. 6(a) to 6(d). FIGS. 6(a) to 6(d) each show a second engaging member 270 (extending radially inwards from the second connector body 202 of the second connector 200) and a first engaging member 271 (extending radially outwards from the first connector body 101 of the first connector 100) during four stages of engagement as the first connector 100 is pulled up towards the second connector 200. In stage 1 (FIG. 6(a)), the first engaging member 271 is approaching but not yet in contact with the second engaging member 270. As the first engaging member 271 is moved closer to the second engaging member 270, the angled run-up surfaces 302 of the pair of engaging members formed by the first engaging member 271 and the second engaging member 270 are brought into mutual contact. With further axial movement of the first connector 100 up through the open channel 206 of the second connector, the inclined nature of the angled run-up surfaces 302 causes lateral movement of the first engaging member 271 relative to the second engaging member 270, by mutual sliding of the angled run-up surfaces 302 at the same time as the first engaging member 271 and the second engaging member 270 also move together axially, as shown in FIG. 6(b). It will be understood that the lateral movement of the first engaging member 271 relative to the second engaging member 270 is achieved in this example by rotation of the second engaging member 270 with the cylindrical ring 259 and relative to the second connector body 202, thereby causing the compression springs 253 to be compressed, as described with reference to FIG. 4 hereinbefore. As the first connector 100 is moved further towards the second connector 200, the first engaging member 271 is moved further axially and past the second engaging member 270, whilst the second engaging member 270 continues to be progressively laterally offset (i.e. rotated) relative to the first engaging member 271. This movement continues until the first engaging member 271 is no longer in contact with the second engaging member 270 by mutual contact between the angled run-up surfaces 302, but is instead in contact with the second engaging member 270 via mutual contact between their respective curved slip surface 304, as shown in FIG. 6(c). As the first engaging member 271 moves fully past the second engaging member 270 the compression springs 253 of the second connector 200 drive the second engaging member 270 back towards the initial lateral position, into what can be considered a locked position, as shown in FIG. 6(d). In the locked position, the straight loaded surfaces 306 of the first and second engaging members 271, 270 are in mutual contact. The compression springs 253 act to thereafter hold the first and second engaging members 271, 270 securely in this state until the system is forced open again to disconnect the first connector 100 from the second connector 200. This completes the mechanical connection. It will be understood that any axial mechanical loading passed through the first connector 100 and the second connector 200 when the first and second connectors 100, 200 are mechanically connected is carried through the contact surface area between the straight loaded surfaces 306.

The electrical and communications connection is completed as the first and second electrical and/or fibre optic contacts are mated. Typically, the electrical and communications connection is made at the same time as the mechanical connection is being made. Thus, after these stages, a mechanical and electrical connection has been secured between the first connector and the second connector.

As a final step the installation line can be removed from the connection eye 112 on the upper bullnose piece 111 of the first connector 100.

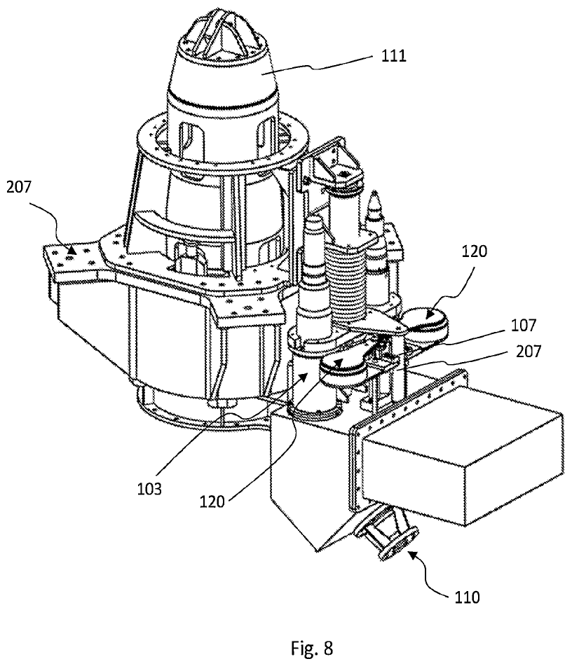

FIGS. 7-8 show the final stages of connection in more detail, in particular allowing the mechanism for electrical connection to be explained. To achieve electrical connection between the first connector 100 and the second connector, the pair of first electrical connectors 103 of the first connector 100 need to be electrically connected with the pair of second electrical connectors 210 of the second connector 200. The electrical connection process will not be described in more detail.

In a fully disconnected configuration, the movable contact covers 120 are provided in a disconnected position, as described with reference to FIGS. 1 and 2 hereinbefore, fully covering the first electrical connectors, and thereby preventing ingress of dirt, biological organisms or any other contaminants which could cause corrosion and/or impede electrical conductivity of the pair of first electrical connectors 103.

As the first connector body 101 of the first connector 100 is moved towards and through the open channel 206 of the second connector 200, the rotational alignment spike 214 of the second connector 200 is brought into contact and engages with the fine rotational alignment channel 107, at the same time as the fine alignment cone 106 of the first connector 100 engages within the fine alignment conical tube 212 of the second connector 200, each to thereby ensure precise rotational alignment between the first and second connectors 100, 200, essential for alignment between the electrical connectors 103, 210. At the same time, the rotational alignment spike 214 also engages with the movable tab 113, causing the movable tab to be depressed to thereby rotate the movable contact covers 120 away from the first position in which each movable contact cover 120 covers the contact surface of the respective first electrical connector 103, towards the second position in which each movable contact cover 120 covers the protection pads 121. FIG. 7 shows the movable contact covers 120 in a position between the first position and the second position. The pair of electrical connectors 103, 210 are not yet in contact until the movable contact covers 120 are fully out of the way.

As the first connector body 101 is moved further through the open channel 206 of the second connector 200, the movable contact covers 120 are fully moved out of the way to sit on the protection pads 121, and the electrical connectors 103, 210 can be brought into contact.

Once the first and second electrical connectors 103, 210 are fully mated, they bottom out and compress the springs 216 retaining the wet mate carriage to allow it to be isolated from any relative motion between the first and second connector bodies 101, 202 in service. This configuration is shown in FIG. 8.

The disconnection process for this embodiment can be achieved by actuation of the release actuators to begin to rotate the secondary engaging members relative to the first engaging members, in a reverse order to the stages shown in FIGS. 6(a) to 6(d) and described hereinbefore in relation to the mechanical connection between the first and second connectors. Once released the first connector is free to drop away from the second connector, thereby also achieving electrical disconnection. During release the moveable contact covers will automatically return to cover the first electrical connectors.

The release actuators can be controlled remotely thereby allowing disconnection of the two connectors without the need for diver intervention or personnel boarding the marine structure. In this embodiment, there are two release actuators, this provides redundancy in the case one actuator fail. It is further possible to release the connection system manually if failure of both actuators should occur. This is achieved by establishing a release line to provide pull in place of the actuator.

In summary, there is provided an offshore connector assembly comprising a first connector (100) and a second connector (200). The first connector (100) comprises a first connector body (101) and a plurality of first engaging members (108), each defining a first engaging surface. The second connector (200) comprises a second connector body (202) and a plurality of second engaging members (204), each defining a second engaging surface (300), configured to form a plurality of engaging surface pairs with the plurality of respective first engaging surfaces when the first connector (100) is connected to the second connector (200). At least one of the first engaging surface and the second engaging surface (300) of each engaging surface pair is configured to be movable relative to its respective first or second connector body (101, 202), between a first engaging surface position in which the first connector (100) is free to move away from the second connector (200), and a second engaging surface position in which, by contact of a first retaining portion of the first engaging surface with a second retaining portion (306) of the second engaging surface (300) of each engaging surface pair, the first connector (100) is mechanically retained relative to the second connector (200). The subsea offshore connector assembly is configured such that at least one of the first engaging surface and the second engaging surface (300) of each engaging surface pair is biased towards the second engaging surface position.

Throughout the description and claims of this specification, the words “comprise” and “contain” and variations of them mean “including but not limited to”, and they are not intended to and do not exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment, or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An offshore connector assembly comprising:
a first connector comprising a first connector body and a plurality of first engaging members, each defining a first engaging surface; and
a second connector comprising a second connector body and a plurality of second engaging members, each defining a second engaging surface, configured to form a plurality of engaging surface pairs with the plurality of respective first engaging surfaces when the first connector is connected to the second connector,
wherein at least one of the first engaging surface and the second engaging surface of each engaging surface pair is configured to be movable relative to its respective first or second connector body, between a first engaging surface position in which the first connector is free to move away from the second connector, and a second engaging surface position in which, by contact of a first retaining portion of the first engaging surface with a second retaining portion of the second engaging surface of each engaging surface pair, the first connector is mechanically retained relative to the second connector, and
wherein the offshore connector assembly is configured such that at least one of the first engaging surface and the second engaging surface of each engaging surface pair is biased towards the second engaging surface position.

2. The offshore connector assembly of claim 1, wherein the plurality of first engaging members are distributed circumferentially about a first connection axis of the first connector, and wherein the plurality of second engaging members are distributed circumferentially about a second connection axis of the second connector.

3. The offshore connector assembly of claim 1, wherein each of the plurality of first engaging members are sized to be no wider than a respective spacing between each of the plurality of second engaging members, and wherein each of the plurality of second engaging members are sized to be no wider than a respective spacing between each of the plurality of first engaging members.

4. The offshore connector assembly of claim 1, wherein the first retaining portion is arranged to face away from a direction in which the first connector is configured to move towards the second connector when the first connector is connecting to the second connector, and the second retaining portion is arranged to face away from a direction in which the second connector is configured to move towards the first connector when the first connector is connecting to the second connector.

5. The offshore connector assembly of claim 1, wherein the first engaging surface of at least one engaging surface pair further comprises a first angled portion, and the second engaging surface of the at least one engaging surface pair further comprises a second angled portion, arranged such that sliding contact between the first and second angled portions is provided when the first connector is moved towards the second connector, whereby to urge movement of the first engaging surface and the second engaging surface of the at least one engaging surface pair towards the first engaging surface position.

6. The offshore connector assembly of claim 5, wherein the first angled portion and the second angled portion of the at least one engaging surface pair are each further arranged such that sliding contact between the first and second angled portions urges movement of the connector body of the at least one of the first engaging surface and the second engaging surface of each engaging surface pair to change axial alignment between the first connector and the second connector during movement of the first connector towards the second connector.

7. The offshore connector assembly of claim 1, wherein the first engaging surface of at least one engaging surface pair further comprises a first slip portion extending from the first retaining portion and the second engaging surface of the at least one engaging surface pair further comprises a second slip portion extending from the second retaining portion, wherein the first slip portion is arranged to contact the second slip portion during movement of the first engaging surface and the second engaging surface of the at least one engaging surface pair from the second engaging surface position when the first connector is mechanically retained relative to the second connector, towards the first engaging surface position, and wherein the first slip portion and the second slip portion are each configured such that, when the first slip portion contacts the second slip portion during movement of the first engaging surface and the second engaging surface of the at least one engaging surface pair from the second engaging surface position towards the first engaging surface position, further movement of the first engaging surface and the second engaging surface of the at least one engaging surface pair from the second engaging surface position towards the first engaging surface position is caused.

8. The offshore connector assembly of claim 1, further comprising a linear actuator operable to exert a movement force on at least one engaging member of the at least one of the first engaging surface and the second engaging surface movable relative to its respective first or second connector body, whereby to cause movement from the second engaging surface position towards the first engaging surface position.

9. The offshore connector assembly of claim 8, wherein the offshore connector assembly is configured such that the at least one of the first engaging surface and the second engaging surface movable relative to its respective first or second connector body is free to move from the second engaging surface position towards the first engaging surface position without operation of the linear actuator.

10. The offshore connector assembly of claim 1, wherein the second engaging surface of each engaging surface pair is configured to be movable relative to the second connector body, between the first engaging surface position and the second engaging surface position.

11. The offshore connector assembly of claim 1, wherein the first connector comprises one or more first electrical contacts, and the second connector comprises one or more second electrical contacts, configured to form one or more electrical contact pairs with the one or more respective first electrical contacts when the first connector is connected to the second connector,
wherein at least one of the first connector and the second connector comprises one or more movable contact covers configured to be movable between a first cover position in which a cover surface of each of the one or more movable contact covers cover the respective first or second electrical contact, and a second cover position in which the cover surface of each of the one or more movable contact covers is removed from the respective first or second electrical contact,
wherein the offshore connector assembly is configured such that:
movement of the first connector towards the second connector causes movement of the one or more movable contact covers from the first cover position into the second cover position, and
movement of the first connector away from the second connector causes movement of the one or more movable contact covers from the second cover position into the first cover position.

12. An offshore connector assembly comprising:
a first connector comprising one or more first electrical contacts; and
a second connector comprising one or more second electrical contacts, configured to form one or more electrical contact pairs with the one or more respective first electrical contacts when the first connector is connected to the second connector,
wherein one of the first connector and the second connector comprises one or more movable contact covers configured to be movable between a first cover position in which a cover surface of each of the one or more movable contact covers cover the respective first or second electrical contact, and a second cover position in which the cover surface of each of the one or more movable contact covers is removed from the respective first or second electrical contact,
wherein the offshore connector assembly is configured such that:
movement of the first connector towards the second connector causes movement of the one or more movable contact covers from the first cover position into the second cover position, and
movement of the first connector away from the second connector causes movement of the one or more movable contact covers from the second cover position into the first cover position.

13. The offshore connector assembly of claim 11, wherein the one or more movable contact covers are comprised in the first connector.

14. The offshore connector assembly of claim 13, wherein the first connector further comprises one or more contact cover bed portions each having a shield surface arranged to cover the respective cover surface when the one or more movable contact covers are in the first cover position.

15. The offshore connector assembly of claim 13, wherein the second connector further comprises one or more elongate protrusions, and wherein the first connector comprises one or more movable portions, mechanically coupled to the one or more movable contact covers, such that movement of the one or more movable portions causes movement of the one or move movable contact covers between the first cover position and the second cover position, and further wherein the offshore connector assembly is configured such that when the first connector is moved towards the second connector, the one or more elongate protrusions together contact the one or more movable portions and cause movement thereof, to move the one or more movable contact covers from the first cover position into the second cover position.

16. The offshore connector assembly of claim 13, wherein the one or more movable contact covers are biased towards the first cover position.

17. The offshore connector assembly of claim 1, wherein the first connector is arranged to extend away from the second connector towards a ground surface, and wherein the second connector is arranged to be provided as part of a deployable marine apparatus, tethered to the ground surface at least partially by the subsea connector assembly.

18. A kit of parts for forming the offshore connector assembly of claim 1, the kit of parts comprising the first connector and the second connector.

19. A first connector for an offshore connector assembly, the first connector as described in claim 1.

20. A second connector for an offshore connector assembly, the second connector as described in claim 1.
